(19) United States
(12) Patent Application Publication
(10) Pub. No.: US 2025/0176758 A1
(43) Pub. Date: Jun. 5, 2025

(54) AIR OUTLET STRUCTURE FOR AIR FRYER

(71) Applicant: SHENZHEN CHENBEI TECHNOLOGY CO., LTD., Shenzhen (CN)

(72) Inventors: Min LIN, Shenzhen (CN); Lei LIU, Shenzhen (CN); Zhibin CHENG, Shenzhen (CN); Xiangyu YIN, Shenzhen (CN); Feng ZHANG, Shenzhen (CN)

(21) Appl. No.: 18/524,863

(22) Filed: Nov. 30, 2023

(51) Int. Cl. A47J 37/06; F24C 15/32

(52) U.S. Cl. CPC A47J 37/0641; F24C 15/325

(57) ABSTRACT

An air outlet apparatus for use in an air fryer includes a first outlet portion connected to a cold air duct for discharging cold air, a second outlet portion below the first outlet portion and connected to a hot air duct for discharging hot air, a first baffle portion opposite to the first outlet portion, an extension portion between the first outlet portion and the first baffle portion, and a mixing chamber for mixing the cold air and hot air. The mixing chamber is surrounded partially by a plane where the first outlet portion is located, the first baffle portion, and the extension portion.

### TECHNICAL FIELD

The present disclosure generally relates to the field of air fryer technology and, more particularly, relates to air outlet structures of air fryers.

### BACKGROUND

Air fryers cook food by circulating hot air (e.g., about 180-200 degrees Celsius) in a cooking chamber. The hot air moves rapidly around the food to fry it. It crisps the surface of the food, while locking the moisture to make it tender inside. When the hot air circulates in the cooking chamber, part of the hot air exits through an air outlet. Sometimes, when an air fryer is placed on a kitchen counter beside a wall, the air outlet is close to the wall. In such cases, the hot air from the air outlet blows upon the wall. A region on the wall that faces the air outlet can be heated up and damaged by high temperatures created by the hot air.

The disclosed apparatus and methods are directed to solve one or more problems set forth above and other problems.

### BRIEF SUMMARY OF THE DISCLOSURE

In one aspect of the present disclosure, an air outlet apparatus for use in an air fryer includes a first outlet portion connected to a cold air duct for discharging cold air, a second outlet portion below the first outlet portion and connected to a hot air duct for discharging hot air, a first baffle portion opposite to the first outlet portion, an extension portion between the first outlet portion and the first baffle portion, and a mixing chamber for mixing the cold air and hot air. The mixing chamber is surrounded partially by a plane where the first outlet portion is located, the first baffle portion, and the extension portion.

In another aspect of the present disclosure, an air outlet apparatus for use in an air fryer includes a first outlet portion connected to a cold air duct for discharging cold air, a first baffle portion opposite to the first outlet portion, an extension portion between the first outlet portion and the first baffle portion, and a second outlet portion disposed on the extension portion and connected to a hot air duct for discharging hot air.

In another aspect of the present disclosure, an air fryer includes a housing, a cold air duct, a hot air duct, and an air outlet apparatus installed at the housing. The air outlet apparatus includes a first outlet portion connected to the cold air duct for discharging cold air, a second outlet portion below the first outlet portion and connected to the hot air duct for discharging hot air, an extension portion extending along a direction away from the first outlet portion, and a first baffle portion at a second end of the extension portion and opposite to the first outlet portion. A first end of the extension portion is connected to a region below the first outlet portion. The first baffle portion, a plane where the first outlet portion is located, and the extension portion partially surround a mixing chamber for mixing the cold air and hot air.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a cross-sectional view of an air fryer in accordance with various embodiments of the present disclosure;

FIG. 2 illustrates an enlarged view of a region C shown in FIG. 1 in accordance with various embodiments of the present disclosure;

FIG. 3 illustrates a perspective view of an air outlet component in accordance with various embodiments of the present disclosure;

FIG. 4 illustrates a perspective view of the air outlet component shown in FIG. 3 from another angle in accordance with various embodiments of the present disclosure;

FIG. 5 illustrates a cross-sectional view of the air outlet component shown in FIG. 3 in accordance with various embodiments of the present disclosure;

FIG. 6 illustrates a perspective view of an air outlet component in accordance with various embodiments of the present disclosure;

FIG. 7 illustrates a perspective view of an air outlet component in accordance with various embodiments of the present disclosure;

FIG. 8 illustrates a perspective view of an air outlet component in accordance with various embodiments of the present disclosure;

FIG. 9 illustrates a perspective view of the air outlet component shown in FIG. 7 in accordance with various embodiments of the present disclosure;

FIG. 10 illustrates a perspective view of an air fryer with an air outlet component in accordance with various embodiments of the present disclosure;

FIG. 11 illustrates a perspective view of an air outlet component in accordance with various embodiments of the present disclosure;

FIGS. 12 and 13 illustrates a top view and a side view of the air outlet component shown in FIG. 11 in accordance with various embodiments of the present disclosure; and

FIG. 14 illustrates a cross-sectional view of an air fryer with an air outlet component in accordance with various embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. Apparently, the described embodiments are merely some but not all of the embodiments of the present disclosure. Features in various embodiments may be exchanged and/or combined.

When a component (or part) is said to be “fixed” to another component, it may be directly on the other component or there may be an intermediate element between the components. When a component is said to be “connected” to another component, it may be directly connected to the other component or there may be an intermediate element between the components. As used herein, the terms “vertical”, “horizontal”, “left”, “right”, and similar expressions are used herein for purposes of illustration only. As used herein, the term “and/or” includes any and all combinations of one or more of the associated listed items.

In an aspect, an air fryer includes a main member, an air outlet component, a hot air chamber, and a cold air chamber. The main member includes a cold air duct for connecting with the cold air chamber and a hot air duct for connecting with the hot air chamber. Part of the hot air in the air fryer is discharged outside through the air outlet component. The air outlet component contains a baffle portion and an extension panel. The baffle portion is connected to a side of the main member. A mixing chamber is formed between the side of the main member and the baffle portion. The mixing chamber connects with the cold air duct and the hot air duct for mixing the cold air and hot air into mixed air. The mixing chamber has a mixed air outlet. The direction along which the air exits the mixed air outlet is different from the direction from the side of the main member to the baffle portion.

In some cases, the main member includes a first portion and a second portion. The first portion is opposite to the baffle portion. The second portion is arranged between the first portion and the baffle portion. The baffle portion and the outer surfaces of the first and second portions form the mixing chamber. Optionally, the side of the mixing chamber opposite to the second portion is open to form the mixed air outlet.

In some cases, the cold air duct runs through the first portion. One end of the cold air duct forms a cold air outlet that sends the cold air to the mixing chamber along a first direction. The hot air duct runs through the first portion. One end of the hot air duct forms a hot air outlet that sends the hot air to the mixing chamber along the first direction. The first direction is from the first portion toward the baffle portion. The cold air outlet and the hot air outlet are arranged along a second direction. The second direction is perpendicular to the first direction.

In some cases, the cold air duct runs through the first portion. The cold air outlet is arranged on a wall surface of the first portion opposite to the baffle portion. The hot air duct runs through the first portion and the second portion sequentially. The hot air outlet is aligned with the mixed air outlet. The extension panel protrudes or extends from the baffle portion along a direction away from the main member.

In some cases, the air outlet component further includes first partitions that divide the cold air outlet into sub-outlets. The first partitions each include a first guiding surface arranged on the inner side of the cold air duct. A corresponding first guiding surface is provided below each of the first air outlets. The higher end of the first guiding surface is close to the mixing chamber. The lower end of the first guiding surface is away from the mixing chamber. In another aspect, an air fryer includes a casing, a shell, an inner shell, an air

outlet component, heating elements, and a heat dissipation component. The shell is placed inside the casing. The casing also houses a cooking chamber with an opening. The inner shell is placed in the shell for sealing the opening. The inner shell includes an inner shell frame and a partition in the inner shell frame. The partition divides the interior of the inner shell frame into a cold air chamber and a hot air chamber. The cold air chamber is located on a side of the hot air chamber away from the cooking chamber.

A main body of the air outlet component penetrates through a sidewall of the shell. A cold air duct connects with the cold air chamber, and a hot air duct connects with the hot air chamber. The baffle portion is spaced apart from the shell and faces the side of the shell.

The heating elements are accommodated in the hot air chamber. The heat dissipation component is accommodated in the cold air chamber.

The shell has a positioning opening. The air outlet component further includes a positioner protruding from the outside surface of the main body of the air outlet component. The positioner is used to fit into the positioning opening on the shell. The air outlet component further includes a snap ring protruding from the outside surface of the main body. The main body is disposed through the side surface of the shell. The snap ring is used to abut against an inner wall of the shell. The air outlet component also includes a first connecting portion, which protrudes from a side of the air outlet component away from the baffle portion. The first connecting portion is held against the inner shell to realize the fixed connection between the air outlet component and the air fryer.

The air outlet component connects the cold air duct with the cold air chamber, and connects the hot air duct with the hot air chamber. The hot air in the hot air chamber is discharged to the mixing chamber through the hot air duct, and the cold air in the cold air chamber is discharged to the mixing chamber through the cold air duct. As such, the cold air and hot air are mixed, and the discharge temperature of the hot air is decreased. The mixing chamber has a mixed air outlet. The air flow direction of the mixed air outlet is different from the direction from the main body to the baffle portion. The baffle portion changes the direction of the mixed air and prevents the mixed air from blowing onto a region of a wall to overheat it. Hence, safety hazards due to the hot air overheating a nearby object may be avoided.

In another aspect, an air outlet component is provided at an air fryer to resolve the heat accumulation problem when hot air is discharged. The air outlet component includes an intake part and an outlet part protruding along the periphery of the intake part. In addition, first outlet portions are respectively provided on the two sides of the outlet part. The first outlet portions each include at least one outlet hole.

In some cases, the outlet part is further provided with a second outlet portion located above two first outlet portions. The air discharge direction of the second outlet portion is a direction away from the intake part. A baffle portion is on a side of the outlet part away from the intake part. The top of the baffle portion protrudes from the top surface of the first outlet portion and is opposite to the outlet of the second outlet portion. The bottom of the baffle portion extends along a sideways direction away from the intake part. The baffle portion has an L-shaped structure optionally. The baffle portion is arranged between the two first outlet portions.

The outlet part protrudes from the periphery of the intake part. The first outlet portions are respectively set on the two sides of the outlet part. As such, the hot air passing through the outlet part is discharged in directions defined by the first outlet portions. Heat accumulation due to hot air blocked by an object (such as a wall) may be avoided.

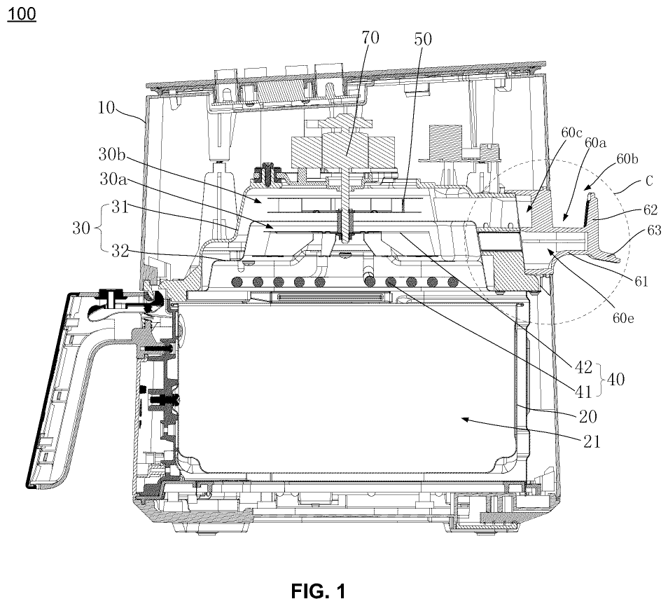

FIG. 1 shows a cross-sectional view of an air fryer 100 according to the present disclosure. The air fryer 100 may be referred to as an electrical apparatus or kitchen appliance. The air fryer 100 includes a shell 10, a chamber housing 20, an inner shell 30, heating elements 40, a heat dissipation component 50, an air outlet component 60, and a driver 70. The shell 10 may also be referred to as a housing 10. As used herein, the term “air outlet apparatus”, “air outlet component”, “air outlet structure”, and “air outlet device” have the same meaning and may be used interchangeably. The chamber housing 20 is configured inside the shell 10 and forms a cooking chamber 21 with an opening. The inner shell 30 is placed inside the shell 10 for sealing the opening. The inner shell 30 includes inner shell frame 31 and a partition 32 placed inside the inner shell frame 31. The partition 32 divides the inside of the inner shell frame 31 into a hot air chamber 30a and a cold air chamber 30b. The hot air chamber 30a connects with the cooking chamber 21. The cold air chamber 30b is located on a side of the hot air chamber 30a away from the cooking chamber 21. The heating elements 40 are accommodated in the hot air chamber 30a. The heating elements 40 include a heating plate 41 and a hot air fan 42. The hot air fan 42 blows the air heated by the heating plate 41 to the cooking chamber 21. The heat dissipation component 50 is inside the cold air chamber 30b and includes a cooling fan for dissipating heat from the heating elements 40 and other electronic components. The driver 70 is connected with and drives the hot air fan 42 and a cold air fan, causing a hot air flow and a cold air flow. The air outlet component 60 passes through a side of the shell 10 and is attached to the inner shell 30. The air outlet component 60 is installed at the shell 10 and used to discharge the cold air in the cold air chamber 30b and the hot air in the hot air chamber 30a to the outside of the shell 10.

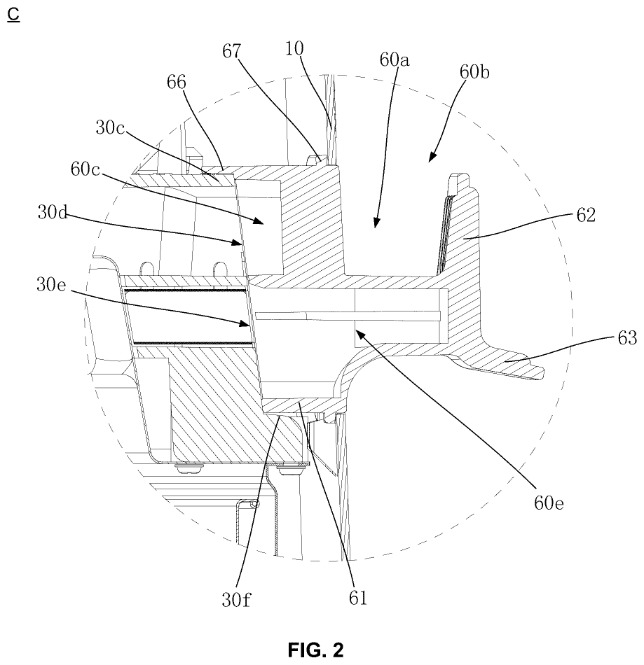

FIG. 2 shows an enlarged view of a region C as shown in FIG. 1 and FIGS. 3-5 show perspective and cross-sectional views of the air outlet component 60 according to the present disclosure. As shown in FIGS. 2-5, the air outlet component 60 includes a main body 61 and a baffle portion 62. The main body 61 includes a cold air duct 60c and a hot air duct 60e. The cold air duct 60c connects with the cold air chamber 30b, while the hot air duct 60e connects with the hot air chamber 30a. The baffle portion 62 is connected to one side of the main body 61 and forms a mixing chamber 60a with the main body 61. The mixing chamber 60a connects with the cold air duct 60c and the hot air duct 60e to mix the cold and hot air into mixed air. The mixing chamber 60a has a mixed air outlet 60b. The air discharge direction of the mixed air outlet 60b is different from the direction from the main body 61 to the baffle portion 62 or a horizontal direction from the shell 20 to the baffle portion 62. After the air outlet component 60 is installed on the air fryer 100, the baffle portion 62 is spaced apart from the shell 10 and is on a side of the shell 10.

The cold air in the cold air chamber 30b is discharged to the mixing chamber 60a through the cold air duct 60c. The hot air in the hot air chamber 30a is discharged to the mixing chamber 60a through the hot air duct 60e. As such, the cold air and hot air are mixed, and the discharge temperature of the hot air is decreased. The air flow direction at the mixed air outlet 60b is different from the direction from the main body 61 to the side where the baffle portion 62 is located. The mixing chamber is formed by the main body 61 and baffle portion 62. The baffle portion 62 changes the flow direction of the mixed air. Optionally, the baffle portion 62 may be spaced apart from the shell 10 and approximately parallel to a circumferential direction with respect to the shell 10. Thus, the baffle portion 62 prevents the mixed air from blowing onto a wall next to the air fryer 10 directly. The temperature of the hot air is lowered by mixing the hot air with the cold air. Issues of overheating a nearby object may be resolved.

As shown in FIG. 2, the main body 61 passes through the shell 10 or a wall of the shell 10. The baffle portion 62 is located outside the shell 10. The mixing chamber 60a, formed by the main body 61 and the baffle portion 62, is also outside the shell 10. The discharged cold air and hot air flow out of the shell 10 first and then are mixed. The temperature of the hot air decreases after being mixed with the cold air. The mixing chamber 60a is arranged such that the mixing process does not affect the flow of the hot air and cold air inside the shell 10. In some cases, the air outlet component 60 and the shell 10 may be integrally formed.

Optionally, the air flow direction at the mixed air outlet 60b is set at an angle with respect to the horizontal direction. That is, the air flow direction at the mixed air outlet 60b is not horizontal. For example, the mixed air may be discharged along a direction that includes and is not limited to an upward direction, a lateral direction, or an upward and sideways direction. The purpose is to avoid the mixed air from being discharged to directly blow on a nearby wall horizontally.

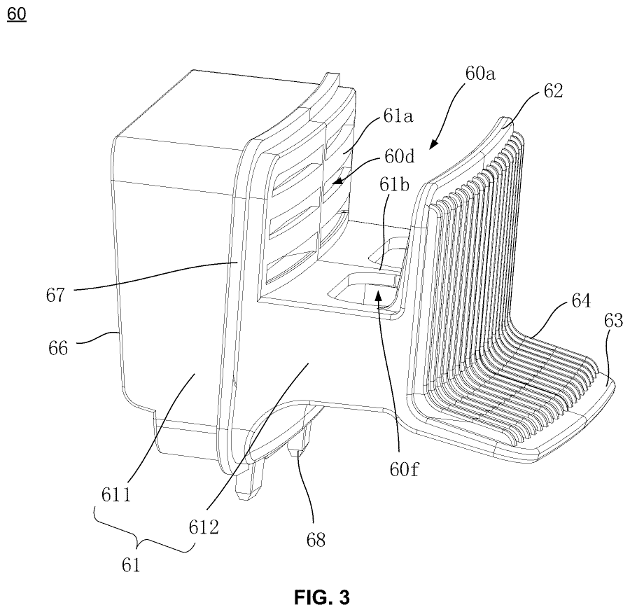

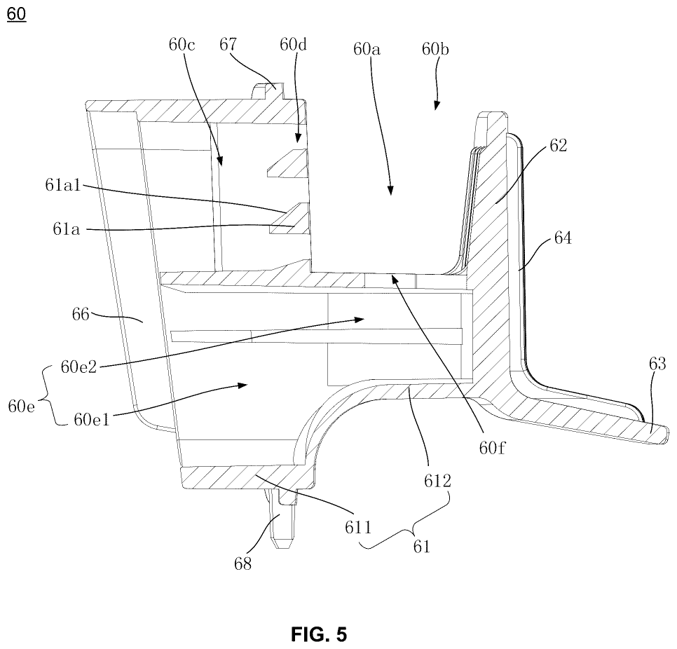

As shown in FIGS. 3 and 5, the mixed air outlet 60b is set upward optionally. Thus, most of the mixed air formed by the mixing process at the mixing chamber 60a is discharged upwards. In some cases, the baffle portion 62 is opposite to and spaced part from a cold air outlet 60d.

With reference to FIGS. 3-5, the main body 61 includes a first portion 611 opposite to the baffle portion 62 and a second portion 612 connected with one end of the first portion 611 and one end of the baffle portion 62. The second portion 612 may be also referred to as an extension portion as it protrudes out and extends from the shell 10. The outer surfaces of the first and second portions 611 and 612 and the baffle portion 62 partially surround a space to form the mixing chamber 60a. The side of the mixing chamber 60a opposite to the second portion 612 is open to form the mixed air outlet 60b. The first and second portions 611 and 612 form an L-shaped structure, while the first and second portions 611 and 612 and the baffle portion 62 form a U-shaped structure. Most of the mixed air formed in the mixing chamber 60a is discharged upwards, and a small part of the mixed air is discharged sideways. Thus, the mixed air is discharged in multiple directions, and the discharge outlet is not limited to the mixed air outlet 60b.

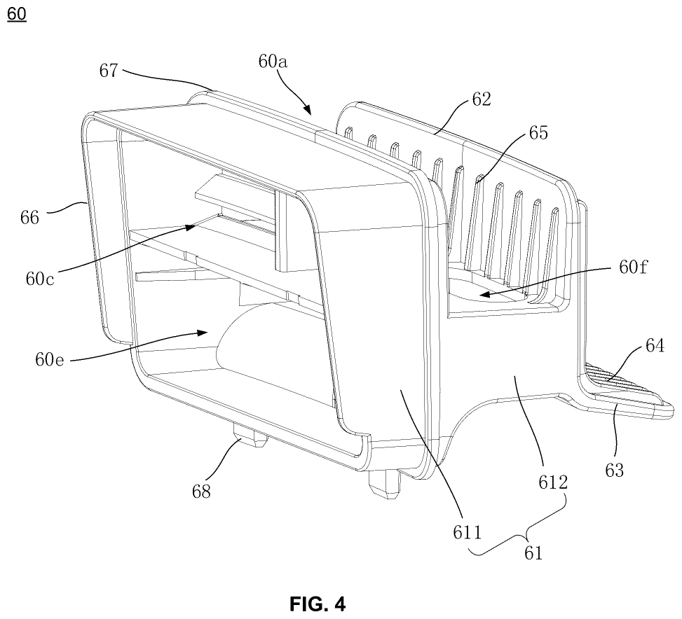

As shown in FIG. 4, the air outlet component 60 further includes second reinforcing ribs 65 on the baffle portion 62. The ribs 65, extending from the top (i.e., the upper end) to the bottom (i.e., the lower end) of the baffle portion 62, cover a side of the baffle portion 62 and the corner between the second portion 612 and the baffle portion 62. The ribs 65 improve the bonding strength between the baffle portion 62 and the main body 61. Optionally, the ribs 65 may also function and be referred to as heat dissipation ribs. For example, the ribs 65 may be made of materials with high thermal conductivity to dissipate heat.

There may be several ways, forms, and combinations to configure the cold air duct 60c and the hot air duct 60e. In some cases, the cold air duct 60c runs through the first portion 611, and one end of the cold air duct 60c forms the cold air outlet 60d. The cold air flows through the cold air duct 60c to the cold air outlet 60d along a first direction. The hot air duct 60e runs through the first portion 611, and one end of the hot air duct 60e forms a hot air outlet 60f. The hot air flows through the hot air duct 60e to the hot air outlet 60f along the first direction. The first direction may be a direction from the first portion 611 to the baffle portion 62, such as a horizontal direction. The cold air fan and hot air fan 42 cause the air to discharge toward the cold air outlet 60d and hot air outlet 60f, respectively. The cold air outlet 60d blows out the air along the first direction, and the hot air outlet 60f also blows out the air along the first direction (not shown). The air from the cold air outlet 60d and hot air outlet 60f is then diverted by the baffle portion 62 to flow in upward and sideways directions.

The cold and hot air ducts 60c and 60e pass through the first portion 611 along the first direction, respectively. That is, both the ducts 60c and 60e extend straight to ensure the flow efficiency of the cold air and hot air.

In some cases, the cold air outlet 60d and the hot air outlet 60f may be arranged along a second direction (not shown). The second direction is approximately perpendicular to the first direction. Most of the cold air and hot is diverted by the baffle portion 62 to flow out upwards along the second direction. As the cold air outlet 60d and the hot air outlet 60f are positioned along the second direction, the hot air passes the cold air when flowing in the second direction, or the cold air mixes with the hot air when flowing in the second direction. Thus, the mixing effect of the cold air and hot air is improved. For example, as shown in FIG. 1, the cold air chamber 30b is configured above the hot air chamber 30a. Thus, the cold air outlet 60d is above the hot air outlet 60f and the hot air may pass the cold air when flowing in the second direction.

As shown in FIG. 5, the air outlet component 60 further includes first partitions 61a. The first partitions 61a divide the cold air outlet 60d into several first sub-air outlets. The first sub-air outlets may also be considered as outlet holes. The first partitions 61a each include a first guiding surface 61a1 on a side of the cold air duct 60c. The first guiding surface 61a1 is correspondingly provided below each first sub-air outlet. The higher end of the first guiding surface 61a1 is close to the mixing chamber 60a, and the lower end of the first guiding surface 61a1 is away from the mixing chamber 60a. Through the first guiding surface 61a1, the cold air may be introduced into the mixing chamber 60a obliquely upwards, reducing the pressure of the cold air blown directly onto the baffle portion 62.

In some cases, the air outlet component 60 further includes second partitions (not shown). The second partitions divide the hot air outlet (not shown) into several second sub-air outlets. The second partitions each include a second guiding surface (not shown) on a side of the hot air duct 60e. A second guiding surface is correspondingly provided below each second sub-air outlet. The higher end of the second guiding surface is close to the mixing chamber 60a, and the lower end of the second guiding surface is away from the mixing chamber 60a. Through the second guiding surface, the hot air may be introduced into the mixing chamber 60a obliquely upwards, reducing the pressure of the hot air blown directly onto the baffle portion 62.

As shown in FIG. 5, in some embodiments, the cold air duct 60c runs through the first portion 611, and the cold air outlet 60d is on a side of the first portion 611 and opposite to the baffle portion 62. The hot air duct 60e runs through the first and second portions 611 and 612 sequentially. The hot air outlet 60f is aligned with the mixed air outlet 60b. To enhance the mixing effect of the hot and cold air, the air discharge direction of the hot air outlet 60f is set such that the discharged hot air passes through the cold air outlet 60d. That is, the cold air duct 60c passes through the first portion 611, a side of the first portion 611 is opposite to the baffle portion 62, and the cold air outlet 60d is arranged on this side of the first portion 611. The hot air duct 60e passes through the first and second portions 611 and 612, and the hot air outlet 60f faces upwards on the second part 612. Then, the air discharge direction of the hot air outlet 60f faces the mixed air outlet 60b. The air discharge direction of the cold air outlet 60d intersects the air discharge direction of the hot air outlet 60f, and the discharge path of the hot air passes through the discharge path of the cold air.

Referring to FIG. 5, the cold air outlet 60d and hot air outlet 60f contain outlet holes and form a first outlet portion and a second outlet portion, respectively. A first end of the second portion 612 is connected to a region (e.g., a part of the first portion 611) below the first outlet portion. The second outlet portion (or the hot air outlet 60f) is below the first outlet portion, above the second portion 612, and faces an upward direction. The direction the first outlet portion faces is approximately perpendicular to the direction the second outlet portion faces. The baffle portion 62 is at and connected to a second end of the second portion 612. The second portion 612 extends along a direction away from the first outlet portion. The baffle portion 62, a plane where the first outlet portion is located, and the second portion 612 (or the second outlet portion) partially surround and form the mixing chamber 60a.

As illustrated above, when the cold air fan and hot air fan 42 rotate, the cold air outlet 60d blows air toward the baffle portion 62 (i.e., in the first direction), and the hot air outlet 60f blows air toward the mixed air outlet 60b (i.e., in second direction). The cold air duct 60c runs through the first portion 611 along the first direction. That is, the cold air duct 60c extends straightly in the first direction, ensuring the efficiency of the cold air passing through the cold air duct 60c. The hot air duct 60e includes a first sub-duct 60e1 and second sub-duct 60e2. The first and second sub-ducts 60e1 and 60e2 are connected with each other, and connected to the hot air chamber 30a and mixing chamber 60a, respectively. The first portion 611 includes the first sub-duct 60e1 along the first direction. That is, the first sub-duct 60e1 extends straightly. The second portion 612 includes the second sub-duct 60e2 along the second direction. That is, the second sub-duct 60e2 extends straightly. First, the hot air in the hot air chamber 30a is led out through the first sub-duct 60e1 along the first direction, and then the flow direction of the hot air is turned through the second sub-duct 60e2. The hot air is discharged along the second direction after passing through the second sub-duct 60e2. It ensures the efficiency of the hot air passing through the hot air duct 60e, and allows the hot air to pass through the cold air in the mixing chamber 60a.

As shown in FIG. 5, the air outlet component 60 has the first partitions 61a, which

divide the cold air outlet 60d into several first sub-air outlets. The first partitions 61a each include the first guiding surface 61a1 on a side of the cold air duct 60c. The first guiding surface 61a1 is correspondingly provided below each first sub-air outlet. The higher end of the first guiding surface 61a1 is close to the mixing chamber 60a, and the lower end of the first guiding surface 61a1 is away from the mixing chamber 60a. Through the first guiding surface 61a1, the cold air may be introduced into the mixing chamber 60a obliquely upwards, reducing the pressure of the cold air blowing directly onto the baffle portion 62.

With reference to FIG. 3, the air outlet component 60 also includes one or more second partitions 61b that divide the hot air outlet 60f into several second sub-air outlets. The first and second sub-air outlets may also be considered as outlet holes. The baffle portion 62 is opposite to and spaced apart from the first sub-air outlets. The first sub-air outlets face a sideways direction. The second sub-air outlets face an upward direction and a space between the baffle portion 62 and the first sub-air outlets (or the cold air outlet 60d). The mixing chamber 60a is partially surrounded by the baffle portion 62 and the first and second sub-air outlets.

In some cases, as shown in FIGS. 3-5, the air outlet component 60 further includes an extension panel 63. The extension panel 63 extends from the baffle portion 62 along a direction away from the main body 61 (or away from the first sub-air outlets). In some cases, the extension panel 63 is part of the baffle portion 62 or the bottom of the baffle portion 62 that extends in a direction away from the first outlet portion. The extension panel 63 is used to define a minimum distance between the baffle portion 62 and a wall next to the air fryer 100. It may avoid potential safety hazards caused by the air fryer 100 being too close to the wall.

In some cases, the air outlet component 60 also includes first reinforcing ribs 64. The first reinforcing ribs 64 are arranged on a side of the baffle portion 62 away from the shell 10, and on the top surface of the extension panel 63. The first reinforcing ribs 64 extend from the top to the bottom of the baffle portion 62 and extend in a sideways direction away from the baffle portion 62. The first reinforcing ribs 64 improve the bonding strength between the baffle portion 62 and the extension panel 63. In some cases, the first reinforcing ribs 64 are referred to as heat dissipation ribs as they may be used to dissipate heat.

With reference to FIGS. 2-5, the air outlet component 60 further includes a snap ring 67 protruding from the peripheral side of the main body 61. The main body 61 passes through a side of the shell 10, and the snap ring 67 is in the shell 10 and abuts against an inner wall of the shell 10. The snap ring 67 keeps the air outlet component 60 attached to the air fryer 100 properly. In addition, the air outlet component 60 also includes a positioner 68 protruding from the outer side of the main body 61. A positioning opening is formed on the shell 10. The positioner 68 is used to fit into the positioning opening on the shell 10. With the positioner 68 and the positioning opening, misalignment between the air outlet component 60 and the inner shell 30 may be avoided.

In some cases, the air outlet component 60 further includes a first connection 66 protruding from an end of the main body 61 away from the baffle portion 62. The first connection 66 is arranged against the inner shell 30 to realize the fixed connection between the air outlet component 60 and the air fryer 100.

As shown in FIG. 2, the inner shell 30 protrudes toward the air outlet component 60 to form a second connection 30c. The second connection 30c includes a first connecting hole 30d and a second connecting hole 30e. The first and second connecting holes 30d and 30e are connected with the cold air chamber 30b and hot air chamber 30a, respectively. The first connection 66 is connected with the second connection 30c. The cold air duct 60c is connected with the first connecting hole 30d, and the hot air duct 60e is connected with the second connecting hole 30e.

As shown in FIG. 2, in some cases, the first connection 66 is wound around the outer side of the second connection 30c, or the second connection 30c is wound around the outer side of the first connection 66. It may ensure the sealing connection between the second connection 30c and the first connection 66.

As shown in FIG. 2, in some cases, the inner shall 30 may include a step 30f. Part of the main body 61 abuts against the step 30f, and supports the air outlet component 60 through the step 30f. It may ensure the stable connection between the first connection 66 and the second connection 30c, and improve the installation stability of the air outlet component 60.

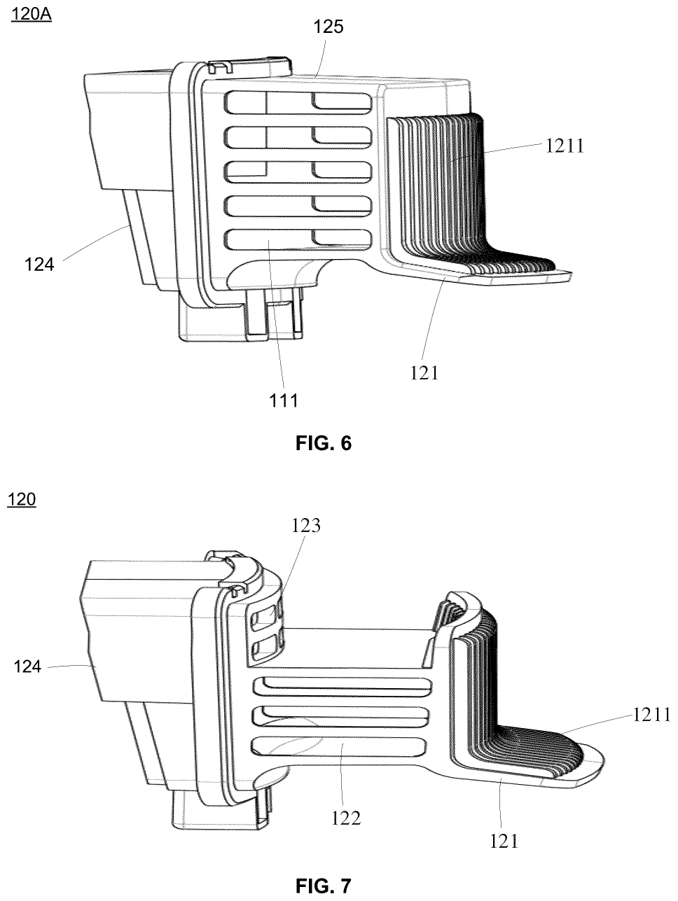

FIG. 6 shows a perspective view of an air outlet component 120A for an air fryer according to the present disclosure. The air outlet component 120A includes an air intake 124 and an air outlet 125. In some cases, the cross section of the air intake 124 is a rectangular structure. The air outlet 125 extends along the periphery of the air intake 124 to form a hollow cover structure connected with the air intake 124. The air outlet 125 is provided with a first outlet portion 111. The hot air enters the air outlet 125 through the air intake 124 and exits the air outlet component 120A through the first outlet portion 111. The first outlet portion 111 contains at least one air outlet hole. The size and number of the air outlet holes may be arranged according to actual needs, such as the amount of heat accumulated in the first outlet portion 111. Optionally, the air outlet holes may have various shapes, such as a round shape, a rectangular shape, an oval shape, etc. For example, as shown in FIG. 6, several air outlet holes may be configures in the first outlet portion 111, with elongated shapes that are parallel to each other. The air outlet component 120A further includes a baffle portion 121. The baffle

portion 121 extends from the air outlet 125 in a sideways direction away from the air intake 124. Heat dissipation ribs 1211 are evenly distributed on the surface of the baffle portion 121. The heat dissipation ribs 1211 is used for strengthening the baffle portion 121 and assisting heat dissipation. In some cases, the baffle portion 121 and heat dissipation ribs 1211 each have an L-shaped structure, and an end of the heat dissipation ribs 1211 is away from the edge of the baffle portion 121.

As shown in FIG. 6, the top part of the baffle portion 121 extends in an upward direction and faces a first sideways direction, while the bottom part of the baffle portion 121 extends approximately along the first sideways direction away from the air intake 124 and air outlet 125. The air outlet holes in the first outlet portion 111 face a second sideways direction approximately perpendicular to the first sideways direction.

In some cases, first outlet portions 111 are provided on the two sides of the air outlet 125. The baffle portion 121 is between the first outlet portions 111 at the two sides. A space is maintained between the air outlet 125 and an object around it. For example, when the air fryer is placed by a wall, a gap may be maintained between the first outlet portion 111 and the wall because of the baffle portion 121. Thus, the air out of the first outlet portion 111 does not blow onto the wall directly, and the problem of hot air bouncing back may be eliminated to a certain extent. Further, it may resolve the problem of heat accumulation and ensure the reliability of the air outlet component 120A.

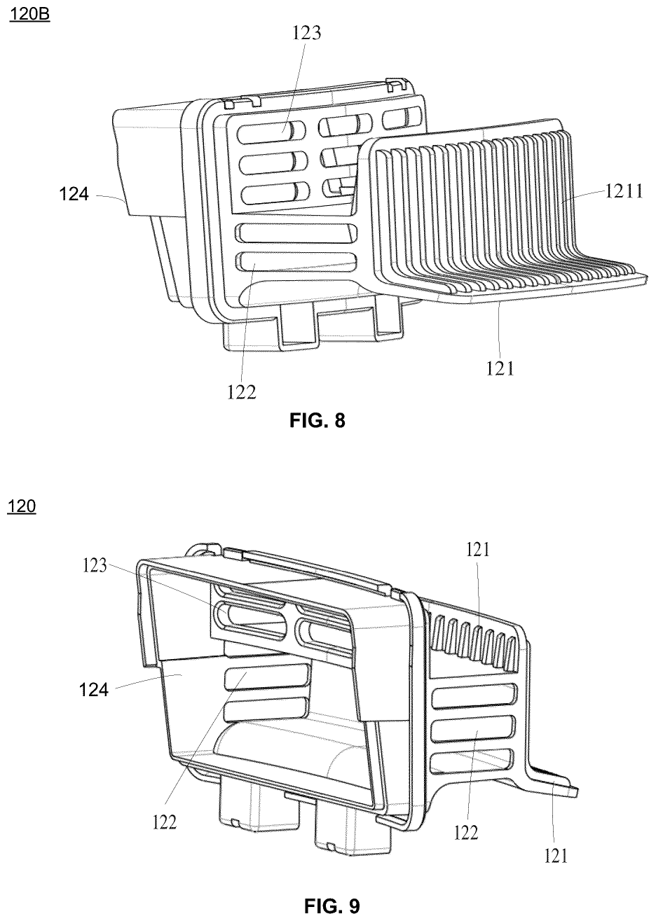

FIG. 7-9 show perspective views of air outlet components 120 and 120B for an air fryer according to the present disclosure. In some cases, the air outlet component 120 includes a second outlet portion 123 located on the top of a first outlet portion 122. The air discharge direction of the second outlet portion 123 is a direction away from the air intake 124. For example, the first outlet portion 122 may protrude from the air intake 124, and the second outlet portion 123 may be attached to the exit end of the air intake 124 and located on the upper part of the first outlet portion 122.

Optionally, the first and second outlet portions 122 and 123 each have air outlet holes. Air outlet holes of the second outlet portion 123 face a first sideways direction away from the housing of the air fryer, while air outlet holes of the first outlet portion 122 face a second sideways direction approximately perpendicular to the first sideways direction. Thus, the facing directions of the first and second outlet portions 122 and 123 are proximately perpendicular to each other, and the air discharge directions of the first and second outlet portions 122 and 123 are proximately perpendicular to each other. In some cases, the first and second outlet portions 122 and 123 are connected to a hot air duct. The hot air flowing from the air intake 124 is discharged through the first and second outlet portions 122 and 123, respectively, i.e., in different directions. Thus issues with heat accumulation may be improved. In some other cases, the first outlet portion 122 is connected to a hot air duct (not shown), and the second outlet portion 123 is connected to a cold air duct (not shown). In such cases, the hot air and cold air are discharged through the first and second outlet portions 122 and 123, respectively.

In some cases, the top part of the baffle portion 121 protrudes from the top surface of the first outlet portion 122 and is opposite to the air outlet holes of the second outlet portion 123. The top part of the baffle portion 121 and the air outlet holes of the second outlet portion 123 face the same sideways direction. After flowing out of the second outlet portion 123, the hot air is diverted by the top part of the baffle portion 121. Then, part of the hot air flows upward in a vertical direction, while part of the hot air flows sideways. Optionally, the bottom of the baffle portion 121 is bent and extends in a sideways direction away from the air intake 124 to ensure that there is no obstruction for air flow around the first and second outlet portions 122 and 123. It also ensures smooth flow of the hot air discharged from the air outlet component 120.

Optionally, the baffle portion 121 has an L-shaped structure, with the top part extending in the upward direction and the bottom part extending in a horizontal direction or a direction having a small angle (e.g., smaller than 45 degrees) with the horizontal direction. In some cases, the structures of the top and bottom parts of the baffle portion 121 may be the same as or similar to that the baffle portion 62 and extension panel 63 as shown in FIGS. 2-5. The baffle portion 121 not only facilitates heat dissipation, but also maintains a certain gap between the air fryer and a nearby object (e.g., a wall). It may prevent the nearby object from blocking the air flow of the air outlet component 120. As aforementioned, the heat dissipation ribs 1211 may be formed on the baffle portion 121. One part of the heat dissipation ribs 1211 extends from the top (i.e., the upper end) to the bottom (i.e., the lower end) of the baffle portion 121, while the other part of the heat dissipation ribs 1211 extends along a sideways direction away from the first and second outlet portions 122 and 123.

In some cases, an extension portion is provided below the first and second outlet portions 122 and 123. The extension portion extends in a direction away from the air intake 124 and second outlet portion 123. One end of the extension portion is connected to a region below the first and second outlet portions 122 and 123. The baffle portion 121 is at the other end of the extension portion. The top part of the baffle portion 121 is opposite to the second outlet portion 123. The bottom part (i.e., the lower end) of the baffle portion 121 extends in a direction away from the air intake 124 and the first and second outlet portions 122 and 123. The first outlet portion 122 is below the second outlet portion 123 and has two parts that are configured on the two sides of the extension portion and opposite to each other.

In some cases, the baffle portion 121 has a curved surface, and the second outlet portion 123 also has a curved surface that corresponds to the curved surface of the baffle portion 121. It may increase the air discharge area of the second outlet portion 123.

In some cases, the air flow of the first and second outlet portions 122 and 123 is proportional to the heat in the two areas, respectively. Adjusting the air flow of the first and second outlet portions 122 and 123 may be used to avoid the heat accumulation issues in the two areas. Based on the air flow inside the air fryer, heat distribution, and structures of the air ducts, the size, shape, and pattern of the first and second outlet portions 122 and 123 may be adjusted. For example, the first and second outlet portions 122 and 123 are arranged differently as shown in FIGS. 7 and 8.

In some cases, the flow rate of the first and second outlet portions 122 and 123 is adjusted by changing the size and number of the outlet holes in the areas. For example, when the first and second outlet portions 122 and 123 are provided with two and three outlet holes, respectively, and the sizes of the outlet holes are the same, the flow rate of the second outlet portion 123 may be higher than that of the first outlet portion 122. When both the first and second outlet portions 122 and 123 are provided with three outlet holes, and the area of the outlet hole of the second outlet portion 123 is twice that of the first outlet portion 122, the flow rate of the second outlet portion 123 may be twice that of the first outlet portion 122. When the first and second outlet portions 122 and 123 are provided with two and three outlet holes, respectively, and the area of the outlet hole of the second outlet portion 123 is twice that of the first outlet portion 122, the flow rate of the second outlet portion 123 may be higher than that of the first outlet portion 122.

Optionally, the air outlet component 120 may be formed by injection molding, die casting, or blow molding. As such, the air outlet component 120 may have good integrity. It also reduces the number of parts, facilitates the assembly work, facilitates mass production, and improves the efficiency of manufacturing.

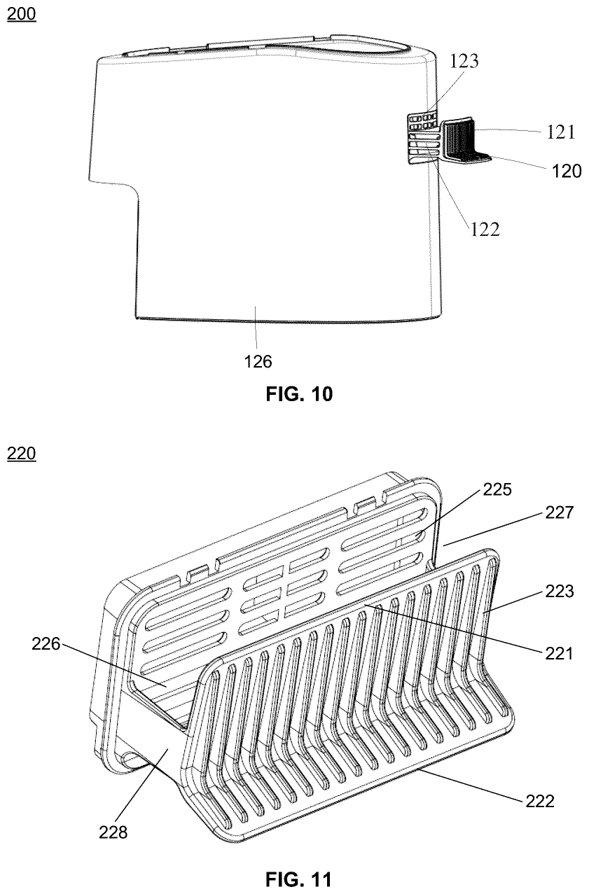

FIG. 10 shows a perspective view of an air fryer 200 with the air outlet component 120 according to the present disclosure. As shown in FIG. 10, the air outlet component 120 is installed at a housing 126 of the air fryer 200, e.g., arranged on the outer surface of the housing 126. The air outlet component 120 protrudes from the housing 126, and the baffle portion 121 protrudes from the first outlet portion 122. The bottom part of the baffle portion 121 is used to maintain a minimum distance between the first outlet portion 122 and a nearby object, and maintain a minimum distance between the top part of the baffle portion 121 and the nearby object.

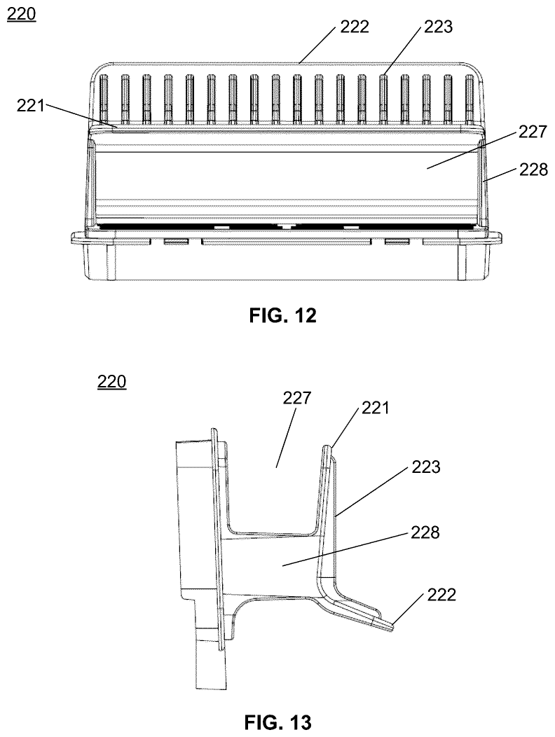

FIGS. 11, 12, and 13 show a perspective view, a top view, and a side view of an air outlet component 220 of an air fryer according to the present disclosure. The air outlet component 220 includes a first outlet portion 225 and a second outlet portion 226 below the first outlet portion 225 for discharging air of the air fryer. The first and second outlet portions 225 and 226 each include air outlet holes. The shape, size, and number of the air outlet holes may be arranged according to actual needs. The air outlet holes may have various shapes, such as a round shape, a rectangular shape, an oval shape, etc.

The air outlet component 220 further includes a baffle portion 221, an extension panel 222, two side panels 228, and a bottom panel (not shown). As shown in FIG. 11, the baffle portion 221 is opposite and parallel to the surfaces of the first and second outlet portions 225 and 226. That is, the baffle portion 221 is opposite to the first and second outlet portions 225 and 226 and the outlet holes thereof along a sideways direction. The side panels 228 and bottom panel are between and connected with the baffle portion 221 and the second outlet portion 226. A mixing chamber 227 is formed and partially surrounded by the baffle portion 221, the first and second outlet portions 225 and 226 (or the outlet holes of the first and second outlet portions 225 and 226), the side panels 228, and the bottom panel. The mixing chamber 227 is arranged to mix discharged air from the first and second outlet portions 225 and 226. One end of the bottom panel is connected to a region below the first and second outlet portions 225 and 226. The baffle portion 221 is at the other end of the bottom panel. The bottom panel extends along a sideways direction away from the first and second outlet portions 225 and 226. The baffle portion 221 is opposite to the first outlet portion 225 or the plane where the first outlet portion 225 is located. The plane where the first outlet portion 225 is located, the baffle portion 221, and the bottom panel form and partially surround the mixing chamber 227. The baffle portion 221, side panels 228, and the second outlet portion 226 partially surround and form at least part of the mixing chamber 227. The plane where the first outlet portion 225 is located is also the plane where an outer surface of the first outlet portion 225 is located.

The baffle portion 221 extends in an upward direction (e.g., approximately vertical direction). The extension panel 222 extends in a sideways direction away from a housing of the air fryer or the first and second outlet portions 225 and 226. The extension panel 222 extends with a certain distance in the sideways direction. The baffle portion 221 and extension panel 222 may include a metallic material, a plastic material, a ceramic material, etc.

Optionally, the extension panel 222 extends in the sideways direction from the bottom part (i.e., the lower end) of the baffle portion 221, and the portion 221 and panel 222 are connected to form an L-shaped structure. In some cases, the extension panel 222 is a bottom part of the baffle portion 221 that extends in a sideways direction away from the first and second outlet portions 225 and 226. The sideways direction may be a horizontal direction or a direction having a small angle (e.g., smaller than 45 degrees) with a horizontal direction.

The air discharged from the air fryer exits through the first and second outlet portions 225 and 226, respectively. Diverted by the baffle portion 221, the air coming out of the first outlet portion 225 flows out in both upward and sideways directions. The air coming out of the second outlet portion 226 is diverted by the baffle portion 221, side panels 228, and the bottom panel to flow upwards. The air from the first and second outlet portions 225 and 226 is mixed in the mixing chamber 227, before being discharged along the upward and sideways directions. The side panels 228 are also used to influence and direct the flow of discharged air and may be referred to as side baffle portions. Optionally, the air outlet component 220 may include an extension portion that contains the bottom panel and side panels 228.

In some cases, the air fryer has a cold air duct connected with a cold air chamber and a hot air duct connected with a hot air chamber. The first and second outlet portions 225 and 226 are connected to the cold air duct and hot air duct, respectively. The cold air and hot air flow through the cold air duct and hot air duct respectively to exit the first and second outlet portions 225 and 226. The cold air and hot air are mixed in the mixing chamber 227, and then discharged. In some other cases, both the first and second outlet portions 225 and 226 are connected with a hot air chamber. The hot air flows out of the first and second outlet portions 225 and 226 simultaneously, gets mixed in the mixing chamber 227, and then is discharged.

In some cases, heat dissipation ribs 223 as rib structures are configured on the baffle portion 221 and extension panel 222. Similar to the heat dissipation ribs (e.g., ribs 64 and 1211 in FIGS. 3 and 7) illustrated above, the heat dissipation ribs 223 improve the panel strength and increase the heat dissipation capability. Optionally, the heat dissipation ribs 223 have a raised L-shaped structure, and the end of the heat dissipation ribs 223 is away from the edge of the extension panel 222. The vertical part of the heat dissipation ribs 223 extends from the top (i.e., the upper end) to the bottom (i.e., the lower end) of the baffle portion 221.

In some cases, the baffle portion 221 and extension panel 222 are built separately and then assembled together by, e.g., bonding. Optionally, the baffle portion 221 and extension panel 222 may be built as a single piece by, e.g., a molding method. In some cases, the air outlet component 220 does not have the side panels 228. As such, the mixing chamber 227 may be formed and partially surrounded by the first and second outlet portions 225 and 226 (or the outlet holes), the bottom panel, and the baffle portion 221. When the side panels 228 are removed, the air flow in the sideways direction is increased, while the air flow in the upward direction is decreased. The embodiment may be useful in some circumstances.

Similar to that illustrated above, the extension panel 222 is used to maintain a minimum distance between the baffle portion 221 (or the air fryer) and an object (e.g., a wall) adjacent to it. Thus, a minimum space may be maintained around the air fryer and hazards of overheating a nearby object may be avoided.

In some cases, small through holes (not shown) are arranged on the baffle portion 221. The small through holes completely penetrate the baffle portion 221 in a sideways direction away from the first and second outlet portions 225 and 226. The small through holes may have various shapes (e.g., a circular shape or a square shape). The number and dimensions of the small through holes may be determined by actual needs. The small through holes provide another passage for the hot air in the mixing chamber 227. A small part of the air in the mixing chamber 227 passes through the small through holes to exit the mixing chamber 227. The small through holes lower the temperature of the discharged air passing through it, while generating air flows with a moderate speed due to the limited size of the through holes. The through holes may improve the efficiency of the air outlet component 220. Further, in some cases, the aforementioned baffle portion 62 and the top part of the baffle portion 121 (as shown in FIGS. 3 and 8) may also have small through holes that penetrate them for the same purpose.

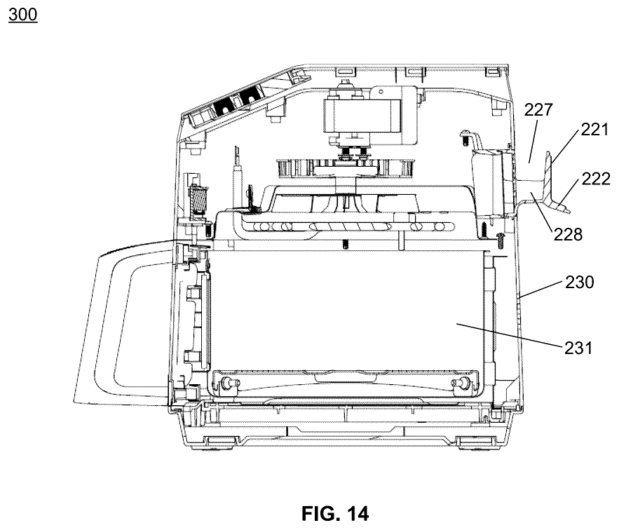

FIG. 14 shows a cross-sectional view of an air fryer 300 where the air outlet component 220 is mounted according to the present disclosure. The air fryer 300 contains a housing 230 and a cooking chamber 231 inside the housing. The housing 230 may also be referred to as a housing or casing of the air fryer 300. As shown in FIG. 14, the air outlet component 220 is installed at or attached to the housing 230. Part of the air outlet component 220 protrudes from the housing 230, the side panel 228 is between the baffle portion 221 and the housing 230, and the baffle portion 221 and side panels 228 surround the mixing chamber 227. The extension panel 222 is used to maintain a minimum distance between the housing 230 and a nearby object, or between the baffle portion 221 and the nearby object. It may prevent the object (e.g., a wall) from being overheated by the hot air from the air fryer 300.

As illustrated above, several embodiments of the air outlet component are presented. Optionally, when it is suitable, features of different embodiments of the air outlet component may be combined. When it is suitable, a feature of one embodiment of the air outlet component may be used for or combined with another embodiment of the air outlet component.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. An air outlet apparatus for use in an air fryer, the air outlet apparatus comprising:
a first outlet portion connected to a cold air duct for discharging cold air;
a second outlet portion below the first outlet portion and connected to a hot air duct for discharging hot air;
a first baffle portion opposite to the first outlet portion;
an extension portion between the first outlet portion and the first baffle portion; and
a mixing chamber for mixing the cold air and hot air and surrounded partially by a plane where the first outlet portion is located, the first baffle portion, and the extension portion.

2. The apparatus according to claim 1, wherein the first and second outlet portions each comprise at least an outlet hole.

3. The apparatus according to claim 1, wherein a lower end of the first baffle portion extends along a direction away from the first outlet portion.

4. The apparatus according to claim 1, wherein the second outlet portion is disposed on the extension portion and faces an upward direction perpendicular to a direction the first outlet portion faces.

5. The apparatus according to claim 1, wherein the extension portion includes a second baffle portion, and the second baffle portion, the second outlet portion, and the first baffle portion surround and form at least part of the mixing chamber.

6. The apparatus according to claim 1, wherein a plurality of heat dissipation ribs is arranged on the first baffle portion and extends from an upper end of the first baffle portion to a lower end of the first baffle portion.

7. An air outlet apparatus for use in an air fryer, the air outlet apparatus comprising:
a first outlet portion connected to a cold air duct for discharging cold air;
a first baffle portion opposite to the first outlet portion;
an extension portion between the first outlet portion and the first baffle portion; and
a second outlet portion disposed on the extension portion and connected to a hot air duct for discharging hot air.

8. The apparatus according to claim 7, wherein the first and second outlet portions each comprise at least an outlet hole.

9. The apparatus according to claim 7, wherein a lower end of the first baffle portion extends along a direction away from the first outlet portion.

10. The apparatus according to claim 7, wherein the second outlet portion faces an upward direction and the first baffle portion, a plane where the first outlet portion is located, and the second outlet portion partially surround a mixing chamber for mixing the cold and hot air.

11. The apparatus according to claim 7, wherein the second outlet portion is disposed on two sides of the extension portion, and a direction the second outlet portion faces is perpendicular to a direction the first outlet portion faces.

12. The apparatus according to claim 7, wherein a plurality of heat dissipation ribs is arranged on the first baffle portion and extends from an upper end of the first baffle portion to a lower end of the first baffle portion.

13. An air fryer, comprising:
a housing;
a cold air duct;
a hot air duct; and
an air outlet apparatus installed at the housing, the air outlet apparatus comprising:
a first outlet portion connected to the cold air duct for discharging cold air;
a second outlet portion below the first outlet portion and connected to the hot air duct for discharging hot air;
an extension portion extending along a direction away from the first outlet portion, a first end of the extension portion connected to a region below the first outlet portion; and
a first baffle portion at a second end of the extension portion and opposite to the first outlet portion, wherein the first baffle portion, a plane where the first outlet portion is located, and the extension portion partially surround a mixing chamber for mixing the cold air and hot air.

14. The air fryer according to claim 13, wherein the first and second outlet portions each comprise at least an outlet hole.

15. The air fryer according to claim 13, wherein a lower end of the first baffle portion extends along a direction away from the first outlet portion.

16. The air fryer according to claim 13, wherein the second outlet portion is above the extension portion and faces an upward direction perpendicular to a direction the first outlet portion faces.

17. The air fryer according to claim 13, wherein the extension portion includes a second baffle portion, and the second baffle portion, the second outlet portion, and the first baffle portion surround at least part of the mixing chamber.

18. The air fryer according to claim 13, wherein a plurality of heat dissipation ribs is arranged on the first baffle portion and extends from an upper end of the first baffle portion to a lower end of the first baffle portion.
